(19) United States
(12) Patent Application Publication
(10) Pub. No.: US 2011/0114491 A1
(43) Pub. Date: May 19, 2011

(54) ENHANCED-SOLUBILITY WATER

(76) Inventors: Vincent J. Pulis, Mississauga (CA); Edward E. Jacobs, Miami Beach, FL (US); Paul Burgert, Santa Rosa, CA (US)

(21) Appl. No.: 13/013,878

(22) Filed: Jan. 26, 2011

Related U.S. Application Data
(62) Division of application No. 11/209,176, filed on Aug. 22, 2005, now abandoned.
(60) Provisional application No. 60/603,893, filed on Aug. 23, 2004.

(51) Int. Cl. C02F 1/48

(52) U.S. Cl. 204/557

(57) ABSTRACT

Methods and apparatus for preparing an enhanced water composition having increased oxygen solubility, and methods for employing the composition to enhance oxygen absorption in tissues for enhancing athletic performance and treating the symptoms of disease are provided herein.

### RELATED APPLICATIONS

This is a divisional application that claims the benefit of U.S. application Ser. No. 11/209,176, filed on Aug. 22, 2005 (which claimed priority to U.S. Provisional Application No. 60/603,893, filed on Aug. 23, 2004), the entire teachings of which are incorporated by reference.

### BACKGROUND OF THE INVENTION

Most methods and systems describe processes for enriching the oxygen content of water by increasing the concentration of dissolved oxygen. Maintaining increased levels of oxygen for lengthy periods of time in an open system has not been possible since the oxygen diffuses out of the water into the atmosphere.

There may be a benefit to exercise performance and treatment of the symptoms of disease, if water with increased oxygen solubility were available, especially for patients with ischemic conditions. Such water could also be used to enhance performance in sports. However, recent publications indicate that previous preparations of “oxygenated water” which contained greater quantities of oxygen did not improve exercise performance.

There is, therefore, a need for improved methods and apparatus for generating water with enhanced oxygen solubility that can benefit exercise performance, or can improve treatment of symptoms of ischemic disease.

### SUMMARY OF THE INVENTION

The invention is directed to an apparatus and a method for increasing the solubility of non-polar gases, such as oxygen in water.

In one embodiment, the apparatus includes at least one cell, each cell defining a conduit. At least two electrode plates are located in the conduit of the cell. An electrical circuit is coupled to the electrode plates. The electrical circuit includes a thyristor, whereby activation of the electrical circuit administers an electrical pulse to the water or combination of water and oxygen gas conducted through the conduit.

In another embodiment, a method of increasing the solubility of water includes the steps of combining water with oxygen and treating the water by applying an electromagnetic pulse in an amount sufficient to cause water to dissolve the oxygen beyond the saturation point of untreated water.

In yet another embodiment, the invention is water having enhanced solubility for oxygen consequent to the method of the invention.

It is believed that enhanced-solubility water (ESW) formed by the apparatus and method of the invention can exhibit long-term stable or metastable oxygen cavities, e.g., when compared to conventionally oxygenated water. ESW can have increased oxygen solubility for at least one day. Further, ESW can have in vivo stability and absorption with measurable physiological effects, as shown in Examples 1-5. ESW can be used to treat the symptoms of disease, and can improve exercise performance. It is believed that the apparatus and method of the invention causes water to dissociate, whereby hydrogen gas (H₂) and oxygen gas (O₂) form. At least a portion of the oxygen gas formed is believed to be entrapped by an arrangement of the remaining molecules. The enhanced-solubility water formed by the apparatus and method of the invention can be employed, for example, to enhance athletic performance in humans.

### BRIEF DESCRIPTION OF THE DRAWINGS

FIG. 1 shows an apparatus 110 as one embodiment of the invention for preparing oxygen enriched water.

FIG. 2 shows a single exciter cell 210 which can be employed in apparatus 110.

### DETAILED DESCRIPTION OF THE INVENTION

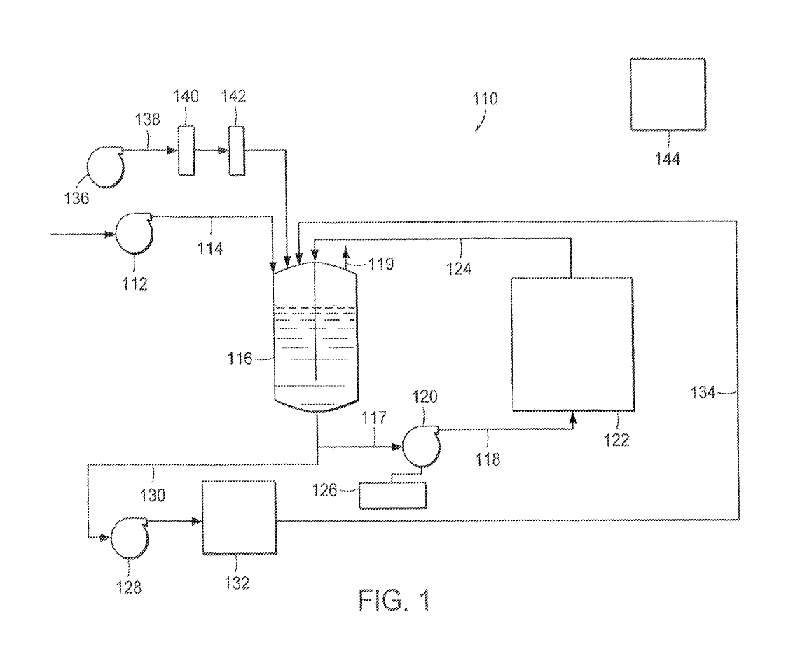

FIG. 1 shows apparatus 110 as one embodiment of the invention for preparing oxygen enriched water. In one embodiment, potable water, e.g., pre-filtered municipal treated water, spring water, and the like, is directed by pump 112 through conduit 114 to tank 116, e.g., a 4,000 US gallon stainless steel conical contact tank. Water from tank 116 is recirculated from tank 116 via conduit 117, main system pump 120 and conduit 118 to reaction chamber 122. Water in reaction vessel 122 is converted to enhanced-solubility water, as described in detail below. The processed water, including hydrogen gas (H₂) generated during conversion of the water, is directed via cell discharge header conduit 124, which enters the top of tank 116 vertically at the center of the tank and extends to a suitable depth, much as a depth of about 72 inches As excited (oxygen-enriched) water enters tank 116, it combines with the water in the tank, creating a mixture of semi-excited and excited water. Hydrogen gas (H₂) formed by the conversion and entrained with the converted water back to tank 116 can be released from tank 116 through vent 119.

Main system pump 120 is controlled by frequency inverter 126 employing a proportional integral derivative (PID) control loop. A second pump 128 also recirculates water from the bottom of tank 116 via conduit 130 through heat exchanger 132 and then returns the water to the top of tank 116 through conduit 134. Heat exchanger 132 can be employed to establish a temperature of the water in a range of between about 0.55° C. and about 1.67° C. Heat exchanger 132 can employ any fluid known to the art, for example, ethylene glycol.

A pressurized clean air blanket can be maintained on top of the water in tank 116 by providing clean pressurized air from air pump 136 through conduit 138, coalescing filter 140 and sanitary filter 142. Typically, the air blanket can extend about 12 inches down from the dome of tank 116, and can be maintained at a pressure of about 241 kilopascals.

A programmed logic controller (PLC) 144 can employ an output instruction to control process variables, e.g., pressure, liquid levels, flow rates, and the like, of the apparatus shown in FIG. 1. The instructions can control the closed loop process using inputs from analog or digital input modules (e.g., pressure sensors, liquid level sensors, thermocouples, flow sensors, and the like) and provide a control output to analog or digital output modules (e.g., a pump, a valve, a heat exchanger, and the like) as a response that can be effective at holding a process variable at a desired set point. Once the predetermined parameters relative to pressure, temperature, and flow are reached and maintained, PLC 144 can initiate power to the cells in reaction chamber 122.

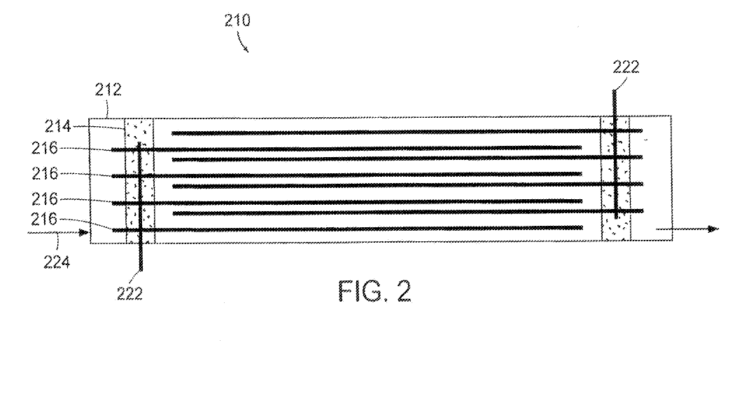

Reaction chamber 122 can typically employ multiple exciter cells, for example, about 40 cells. The cells are housed in the reaction chamber 122. FIG. 2 shows a single cell 210. The cell can be constructed with rigid tubing 212, e.g., polyvinyl chloride (PVC) tubing, about 7.6 cm inside diameter and about 120 cm long. A rigid insulating spacer 214, e.g., made of PVC, is employed to hold the electrode plates 216. Electrode plates 216 can be about 5 cm wide, about 100 cm long titanium plates with about 100 micro-ohms coating of platinum. Plates 216 are held by spacer 214 in 2 sets (for positive and negative) of 4 plates each as shown. Plates 216 are spaced at about 6.4 millimeters between the two sets. Each set can be terminated with a 316 stainless steel stud 222 that exits cell 210. Water is directed through each cell, perpendicular to plates 216, in between the plates 216, in a direction indicated by arrow 224. The water flow rate through each cell typically is adjusted to be laminar and can be calibrated with a non-invasive flow meter and logged.

An example of circuitry for operating reaction chamber 122 (FIG. 1) can be described as follows. An isolation transformer (k-8) steps down the primary 600 volts 3-phase from a power supply to a multiple tap secondary of 10-20 volts alternating current (AC), 3-phase. The 3-phase AC secondary is fed into a thyristor, for example, a 500 amp three phase thyristor direct current (DC) converter for conversion to DC. In one embodiment, the thyristor includes twelve silicon controlled rectifiers arranged as a four quadrant operation. The thyristor is employed to excite the cells with six silicon controlled rectifiers (SCR) and a four quadrant circuit arrangement. Reaction chamber 122 is gate-triggered into conduction by firing boards. Reaction output load is fed into diversionary board. PLC 144 enables a PID ramp sequence that applies DC to the cells in the reaction chamber. Cell amps and voltages are ramped up and down as a function of time to excite the cell electrode plates. Alternation of DC power can be reversed to the cells about, for example, every 30 minutes. Currents are first applied at, for example, about 5.0 amps DC per cell at voltages that are relevant to the conductivity of the incoming supply water. Time ramping begins and continues until about 10 amps per cell can be maintained. The complete production process can run about 3.5 to 4 hours under these conditions, producing about 3280 US gallons of water having about 28 to about 35 milligrams per liter of oxygen.

Exemplary specifications for one example of the apparatus are provided in Example 6.

Enhanced-solubility water (ESW) is an improved water/oxygen composition. Unlike normal water exposed to the atmosphere which contains 8-9 mg/l of O₂, it is believed that ESW can contain approximately three times the normal oxygen content (i.e., 28-35 mg/l). It is also believed that this enhanced concentration in oxygen can remain elevated in an open container for more than one day. After agitation (stirring), few or no bubbles are typically formed and there is little or no decrease in oxygen content compared to that observed when water is conventionally oxygenated, e.g., pressurized with oxygen.

Without wishing to be bound by theory, the increased oxygen solubility of ESW is believed to be related to a change in water structure resulting from the process, which includes electromagnetic treatment. This treatment increases the size of cavities in water, which can enhance the ability of water to assimilate more oxygen. Furthermore, the property of increased solubility seems to be retained after ESW is consumed and enters the bloodstream, as suggested by the improved performance in the Examples. The normal consumption and gastrointestinal absorption of ESW could result in improved oxygen solubility and diffusion in plasma. ESW in the bloodstream is believed to enhance the release of oxygen from red blood cells with the end result of increasing the efficiency of delivery of oxygen to tissues. The net effect of increased delivery is reflected in physiologic benefits in healthy people.

Without wishing to be bound by theory, one interpretation of these observations, in accordance with liquid state physics and with the non classical nucleation theory, is that a proportion of the oxygen content in ESW is dissolved in the form of small oxygen clusters trapped into cavities of sub-nanometer size. These cavities can fluctuate in time due to the fluidity of the liquid and can be composed on average of several tens of water molecules. By contrast, in untreated water, the atmospheric oxygen is believed to be solvated exclusively under the form of single (monomeric) oxygen molecules rather than clusters. The existence of larger cavities in ESW containing oxygen clusters is believed to be due to the well known propensity of the hydrogen bond network in liquid water to make cavities which appear and disappear at the fluctuations of the cavities (the time scale of these microscopic fluctuations is of the order of picoseconds). When these cavities trap a few oxygen molecules (other non polar molecules can also be used) they are believed to be stabilized by an entropy-enthalpy compensation mechanism. Nevertheless these cavities containing oxygen clusters can be metastable with respect to the equilibrium situation which otherwise favors monomeric species. Consequently at the macroscopic level, it is observed that ESW is metastable over a period of time which exceeds one day at normal thermodynamic conditions.

In liquid water, under ambient conditions, the spontaneous transient cavities can be defined by a shell of water molecules which resembles a clathrate structure found in certain forms of ice (see illustration below). In the liquid state the average number of H₂O molecules forming the shell of these cavities capable to encapsulate inert and nonpolar gases is believed to be between 20 and 25 and the space enclosed by the shell is large enough to hold a single (monomeric) O₂ molecule. In untreated water, the occurrence of large cavities, i.e. with a shell composed of greater than about 25 water molecules is believed to be rare since it is given by the exponential of the entropy cost to form the cavity in the bulk (work of cavity formation). For example, the probability to observe a cavity composed of around 25 water molecules is roughly two orders of magnitude smaller than that to observe a cavity composed of 20 molecules.

In contrast, in ESW, which is believed to contain up to three times the amount of dissolved oxygen, two or more oxygen molecules are believed to be contained in larger cavities whose shells are believed to be correspondingly larger. However, it also believed that the intermolecular interactions between the oxygen molecules and water molecules balance to a large extent the entropy cost of cavity formation. These larger shells are believed to be composed of more than about 35 H₂O molecules.

ESW is believed to be related to the existence of these multiple larger cavity shells consisting of more than about 35 H₂O molecules.

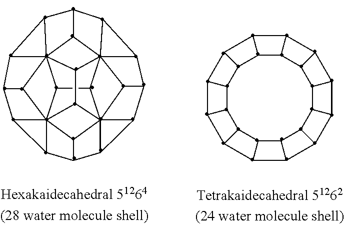

In the above illustration, examples of clathrate-type structures approximately the size of water shells which can accommodate single O₂ molecules in untreated water are shown, where for clarity only the oxygen part of the H₂O molecules are shown (as the vertices of the figures).

### EXEMPLIFICATION

### Human Effects

In order to demonstrate the physiologic and performance effects of ESW in healthy individuals, several exercise studies were conducted using elite cyclists. The studies demonstrated that consuming ESW results in significantly lower heart rates at fixed work loads as well as increased speeds at fixed heart rates when compared to effects seen when the cyclists consumed equal volumes of untreated water.

In patients with suboptimal regional oxygenation related to lower extremity arterial disease, consuming ESW resulted in a delay in the onset of ischemic symptoms and a decrease in the recovery time.

### Example 1

### Sub-Maximal Exercise Study

This study was a single blind, two-way crossover, tap water controlled, sub-maximal exercise study to determine the effect of ESW on heart rate during static sub-maximal bicycle exercise testing. Sixteen elite male and female cyclists utilizing their own bicycles were enrolled in the study. Baseline workload was standardized by determining each cyclist's lactate (anaerobic) threshold (LT) (Conconi Test) while performing a graded static exercise test at four resistance settings: (1) 80% of LT, (2) 80%+20 watts, (3) 80%+40 watts, (4) 80%+60 watts.

The testing was performed on a computerized static testing stand (Compu Trainer Racer Mate™) utilizing a PC 1™ power pack. Heart rate was measured with a PolarX Training Heart Rate™ monitor at the end of three minutes for each of the four resistance levels.

Group I drank 500 mL of ESW and Group II drank 500 mL of tap water (blinded) during each 30 minute period for three hours before repeating the test. In a crossover study the same baseline and repeat tests were performed again with the groups switching the type of water that was consumed.

The heart rates at baseline and at different resistances were statistically compared for each group utilizing Student's t-test (2 tailed). P<0.05 was considered statistically significant.

The data demonstrated that there were no significant changes in heart rate after drinking tap water at any resistance level for either group. In contrast, there was a significant decrease in heart rate for all resistance levels after drinking the ESW.

The relationship of cardiac output and heart rate to workload and oxygen consumption is well documented in the context of exercise performance. For a healthy athlete, in the absence of training effects or variation in baseline parameters, repeated exercise at a fixed resistance (workload) can be accomplished at a similar heart rate. In this study, training effects and variation in baseline parameters could be minimized by repeatedly testing each cyclist in a comparable sub-maximal range of four resistances. A comparison of each cyclist's heart rate during graded exercise before and after drinking ordinary tap water on one day revealed that there was no change in heart rate, confirming that there were no effects from the trial design which could produce a significant change in heart rate.

In contrast, in this two way cross-over study, the cyclists repeated the same exercise performance before and after drinking ESW, and were found to have significantly lowered heart rates. Therefore the observed physiologic effect of drinking ESW, when compared to untreated water, is to decrease the heart rate of healthy individuals while performing multiple work loads.

### Example 2

### Fixed Heart Rate Pilot Study

This study was a single-blind, tap water controlled, sub-maximal exercise test to determine the effect of drinking ESW on the time taken to complete a simulated distance of five miles while pedaling at a predetermined heart rate during static sub-maximal bicycle exercise testing.

Twelve elite male and female cyclists, utilizing their own bicycles, were randomized and divided into two group of six to drink either tap water or ESW for the first test and the alternative water for the cross-over experiment. Exercise was standardized by the maintenance of a fixed heart rate by each cyclist, which represented 80% of each cyclist's lactate (anaerobic) threshold (LT). The anaerobic threshold was determined by historical data or testing (Conconi Test). After appropriate warm up, the riders pedaled their own bicycles at a rate to maintain their designated heart rate over a five mile simulated distance using a computerized static testing stand (CompuTrainer Racer Mate™) with a PC 1™ power pack. Heart rate was measured with a PolarX Training Heart Rate™ monitor. Monitors also recorded each cyclist's time to reach sequential mile markers until completion of the entire five mile simulated distance.

On the day before the test, each rider drank six 500 mL bottles of either tap water or ESW. The next day, over a 90 minute period beginning 120 minutes before the test, each rider drank three more 500 mL bottles. After a ten minute warm up, the riders performed a static test at a predetermined heart rate over a simulated distance of five miles. Monitors checked the heart rate to insure that the actual rate remained within two beats of the designated rate.

On the third day, the same hydration schedule and static test were repeated after each rider switched to drinking the alternative water.

The time to complete the simulated five mile distance after drinking either water was statistically compared utilizing Student's t-test (2 tailed). P<0.05 was considered to be significant.

All riders were able to complete the protocol. After drinking ESW there was a significant decrease in the time needed to complete the five mile simulated distance. (p-0.0357).

In this study the performance effect of ESW resulted in a benefit in the form of increased cycling speed. While under normal race conditions cyclists do not typically maintain a fixed heart rate, this study provides data to support the conclusion that a greater speed (i.e., work output) can be generated at similar heart rates after drinking ESW when compared to tap water.

Without wishing to be bound by theory, absorption of ESW into the bloodstream is believed to improve the solubility of oxygen in plasma resulting in increased diffusion (extraction) of oxygen from red blood cells. Since oxygen availability to tissues depends upon the reciprocal relationship between cardiac output, reflected in heart rate, and oxygen extraction, the increased work output at a fixed heart rate is likely due to increased oxygen extraction.

### Example 3

### Double Blind Fixed Heart Rate Pilot Study

This study was a double-blind, tap water controlled, sub-maximal exercise study to determine the effect of drinking ESW on the time taken to complete a simulated distance of ten miles while pedaling at a predetermined heart rate during static sub-maximal bicycle exercise testing.

Forty-three adult elite male and female cyclists, utilizing their own bicycles, were randomized into two groups, one group to drink tap water and the other to drink ESW. Both cyclists and test monitors were blinded to the identity of the water during the test. Exercise was standardized by the maintenance, by each cyclist, of a fixed heart rate which represented 80% of the cyclist's lactate (anaerobic) threshold (LT). The anaerobic threshold was determined by historical data or testing (Conconi Test). After appropriate warm up, the riders pedaled their own bicycles at a rate to maintain their designated heart rate over a ten mile simulated distance on a computerized static testing stand (CompuTrainer Racer Mate™) utilizing a PC 1™ power pack. Heart rate was measured with a PolarX Training Heart Rate™ monitor.

Both the riders and the study monitors were blinded regarding each rider's speed and the type of water consumed before each test. Additional monitors who were also blinded recorded each cyclist's time to reach sequential mile markers until completion of the entire ten mile simulated distance.

On each of the two days preceding the test day, each rider drank six 500 mL bottles of either tap water or ESW. On the test day, after a light breakfast, each rider drank three more 500 mL bottles over a 90 minute period beginning 120 minutes before the test, if they weighed less than 140 pounds. If the rider weighed 140 pounds or more, they drank four 500 mL bottles over a 120 minute period beginning 150 minutes before the test.

After a ten minute warm up, the riders performed a static test at a predetermined heart rate over a simulated distance of ten miles. Monitors and riders continuously checked the heart rate to insure that the actual rate remained within two beats of the designated rate. Additional blinded monitors recorded the time required for each rider to pass each mile marker and to complete the ten mile simulated course.

Cross-over testing occurred seven days after the initial test. The same hydration schedule and static test were repeated with each group drinking the alternative water.

The time to complete the simulated ten mile distance after drinking either tap water or ESW was statistically compared utilizing Student's t-test (2 tailed). P<0.05 was considered to be significant.

Of the forty-three riders, two were unable to complete the protocol: one rider had a mechanical failure of his bicycle and the other was not able to maintain a consistent pulse at the designated heart rate. After drinking ESW there was a significant decrease in the time needed to complete the ten mile simulated distance. (p=0.0364). The average decrease in time to completion was 29 seconds or, 1.4 percent of the average total time.

Consistent with previous studies, these results confirm that the performance effect of drinking ESW can be translated into a benefit in the form of increased cycling speed. While it is true that under normal race conditions cyclists do not maintain a fixed heart rate, this study provides data to support the conclusion that a greater speed (i.e., work output) can be generated at similar heart rates after drinking ESW when compared to tap water.

Without wishing to be bound by theory, the absorption of ESW into the bloodstream is believed to improve the solubility of oxygen in plasma, resulting in increased diffusion (extraction) of oxygen from red blood cells. Since oxygen availability to tissues depends upon the reciprocal relationship between cardiac output, reflected in heart rate, and oxygen extraction, the increased work output at a fixed heart rate is probably due to increased oxygen extraction.

### Example 4

### Single-Blind Claudication Pilot Study

This study was a single-blind, tap water controlled, treadmill exercise test to determine the effects of drinking ESW on the onset, duration to maximum intensity and time to recovery of claudication (lower extremity pain) in patients with known lower extremity peripheral vascular disease.

Fourteen adult male and female patients, ages 36 to 70, and with documented claudication from peripheral vascular disease, performed baseline treadmill exercise testing followed by drinking 1 liter of either untreated (UW) or ESW over 90 minutes. After a 30 minute relaxation period, the treadmill test was repeated. In a cross-over study the next day, the procedure was repeated with the patients drinking the alternative water.

The treadmill test was performed at a fixed speed of 2.0 to 3.5 km/hr. The incline was started at 2% and was increased by 2% every 2 minutes until the termination of the test due to onset of pain. Measurements included time to start of lower extremity pain, end of maximum pain, and relief of pain; heart rate at rest, at the end of each 2 minute walking period, at the start of pain and at the relief of pain; and blood pressure at rest and at the relief of pain.

Patient physiological reactions (heart rate and blood pressures), while walking on the treadmill at a constant speed, during the tests on both days, were within an expected normal range.

The heart rate at the time of maximum pain was 80% of the expected age maximum for the patients confirming pain due to claudication rather than other causes. Consumption of ESW improved the longevity of work load (walking) by 10.4% and improved time to first pain by 13.6%. The delay in occurrence of maximum pain was statistically significant (p<0.05). The recovery period after maximum pain was shortened by 31% after drinking ESW (p<0.001). Heart rate was consistently lower in the group administered ESW compared to untreated water. ESW showed statistically significant physiological effects on the patients in this study. The onset of pain due to claudication in the lower extremities was delayed after the consumption of ESW. In addition, the recovery time after the onset of pain was shorter.

### Example 5

### Double-Blind Claudication Pilot Study

This study was a double-blind, tap water controlled, treadmill exercise test to determine the effects of drinking ESW on the onset, duration to maximum intensity, and time to recovery of lower extremity pain in patients with known lower extremity peripheral vascular disease (claudication).

Twenty-four male and female patients (Table 1), ages 43 to 71, with documented claudication from peripheral vascular disease performed a baseline treadmill exercise test (T1) followed by drinking 1 liter of either untreated (UW) or ESW over 90 minutes and then repeating the identical exercise test (T2). In a cross-over study the next day, the same procedure was repeated but the patients consumed the alternative water.

TABLE 1
Double-Blind Claudication Pilot Study Results

| | | | Dopler Method | | Speed of Walk |
|---|---|---|---|---|---|
| | | | Sys | Sys Ankle, | on Treadmill |
| | Sex | Age | Brach/Ankle | mm Hg | km/hr |
| 1 | M | 63 | 0.60 | 97 | 3.5 |
| 2 | M | 63 | 0.57 | 80 | 4.0 |
| 3 | M | 53 | 0.48 | 60 | 2.5 |
| 4 | M | 65 | 0.84 | 138 | 3.0 |
| 5 | M | 68 | 0.91 | 130 | 3.5 |
| 6 | M | 58 | 0.84 | 134 | 2.5 |
| 7 | M | 71 | 0.68 | 87 | 3.5 |
| 8 | M | 62 | 0.85 | 115 | 3.0 |
| 9 | M | 67 | 0.62 | 97 | 2.5 |
| 10 | F | 43 | 0.85 | 102 | 3.5 |
| 11 | M | 48 | 0.82 | 140 | 3.5 |
| 12 | M | 53 | 0.63 | 95 | 2.5 |
| 13 | F | 63 | 0.82 | 138 | 3.0 |
| 14 | M | 48 | 0.54 | 64 | 3.0 |
| 15 | M | 62 | 0.55 | 85 | 3.5 |
| 16 | M | 44 | 0.61 | 85 | 3.5 |
| 17 | M | 52 | 0.62 | 84 | 3.0 |
| 18 | M | 47 | 0.83 | 100 | 4.2 |
| 19 | F | 65 | 0.59 | 92 | 2.0 |
| 20 | F | 48 | 0.83 | 135 | 2.5 |
| 21 | F | 51 | 0.64 | 88 | 3.5 |
| 22 | F | 66 | 0.89 | 145 | 2.8 |
| 23 | F | 55 | 0.74 | 104 | 3.7 |
| 24 | M | 57 | 0.66 | 77 | 2.5 |

The treadmill test was performed at a fixed speed of 2.5 to 4.2 km/hr (Table 1). The incline started at 2% and was increased by 2% every 2 minutes until the termination of walking due to pain. Data obtained included time at end of maximum pain, and relief of pain, heart rate at rest, at the end of each 2 minutes of walking, at the end of maximum pain and at the relief of pain and blood pressure at rest and at the relief of pain. The testing results (duration of walking and recovery) are summarized in Table 2.

TABLE 2
Testing Data

| | Untreated Water (UW) | | | | | | ESW | | | | | |
|---|---|---|---|---|---|---|---|---|---|---|---|---|
| | | | T2 − | | | T2 − | | | T2 − | | T2 | T2 − |
| | T1 | T2 | T1 | T1 | T2 | T1 | T1 | T2 | T1 | T1 | End | T1 |
| | Max | Max | Max | End | End | End pain | Max | Max | Max | End | pain, | End pain |
| Subject | pain, sec | pain, sec | pain Diff | pain, sec | pain, sec | Diff | pain, sec | pain, sec | pain Diff | pain, sec | sec | Diff |
| 1 | 665 | 615 | −50 | 208 | 218 | 10 | 943 | 858 | −85 | 205 | 93 | −112 |
| 2 | 495 | 385 | −110 | 306 | 288 | −18 | 434 | 479 | 45 | 298 | 264 | −34 |
| 3 | 286 | 273 | −13 | 280 | 298 | 18 | 245 | 273 | 28 | 340 | 286 | −54 |
| 4 | 428 | 418 | −10 | 198 | 206 | 8 | 495 | 585 | 90 | 173 | 160 | −13 |
| 5 | 720 | 785 | 65 | 315 | 345 | 30 | 717 | 735 | 18 | 241 | 131 | −110 |
| 6 | 960 | 962 | 2 | 131 | 135 | 4 | 960 | 1103 | 143 | 167 | 108 | −59 |
| 7 | 416 | 419 | 3 | 340 | 220 | −120 | 504 | 579 | 75 | 249 | 341 | 92 |
| 8 | 440 | 400 | −40 | 495 | 155 | −340 | 355 | 419 | 64 | 368 | 154 | −214 |
| 9 | 189 | 194 | 5 | 367 | 263 | −104 | 180 | 331 | 151 | 276 | 255 | −21 |
| 10 | 965 | 960 | −5 | 370 | 205 | −165 | 1045 | 1211 | 166 | 197 | 167 | −30 |
| 11 | 376 | 421 | 45 | 302 | 276 | −26 | 265 | 465 | 200 | 300 | 203 | −97 |
| 12 | 315 | 322 | 7 | 185 | 195 | 10 | 305 | 392 | 87 | 209 | 176 | −33 |
| 13 | 964 | 865 | −99 | 107 | 140 | 33 | 968 | 980 | 12 | 112 | 100 | −12 |
| 14 | 518 | 607 | 89 | 325 | 263 | −62 | 522 | 595 | 73 | 316 | 260 | −56 |
| 15 | 405 | 442 | 37 | 333 | 300 | −33 | 385 | 410 | 25 | 325 | 285 | −40 |
| 16 | 350 | 792 | 442 | 255 | 142 | −113 | 330 | 425 | 95 | 264 | 220 | −44 |
| 17 | 457 | 571 | 114 | 242 | 162 | −80 | 444 | 631 | 187 | 214 | 210 | −4 |
| 18 | 820 | 840 | 20 | 194 | 148 | −46 | 829 | 853 | 24 | 150 | 181 | 31 |
| 19 | 228 | 231 | 3 | 145 | 160 | 15 | 204 | 285 | 81 | 186 | 162 | −24 |
| 20 | 423 | 377 | −46 | 163 | 154 | −9 | 468 | 601 | 133 | 140 | 124 | −16 |
| 21 | 528 | 592 | 64 | 152 | 200 | 48 | 564 | 705 | 141 | 160 | 140 | −20 |
| 22 | 311 | 307 | −4 | 158 | 154 | −4 | 310 | 418 | 108 | 186 | 140 | −46 |
| 23 | 904 | 736 | −168 | 228 | 198 | −30 | 660 | 680 | 20 | 310 | 270 | −40 |
| 24 | 177 | 172 | −5 | 252 | 260 | 8 | 174 | 253 | 79 | 388 | 379 | −9 |
| mean | 514.2 | 528.6 | 14.4 | 252.1 | 211.9 | −40.3 | 512.8 | 594.4 | 81.7 | 240.6 | 200.4 | −40.2 |
| SD | 250.4 | 244.1 | 110.4 | 94.0 | 61.3 | 84.1 | 269.3 | 259.2 | 65.8 | 77.0 | 77.3 | 56.1 |

The duration of walking on the treadmill was increased significantly (p<0.001) after the patients consumed ESW. On average, the increase was 82 seconds which signified a 16% improvement. In contrast, after drinking untreated water, there was no improvement in the duration of walking (p=0.529).

These results suggest that the drinking of ESW delays the onset of maximal pain in the participants. In addition, recovery (time to complete disappearance of pain) was shorter, despite walking longer on the treadmill after drinking ESW. Furthermore, exercise induced physiologic effects on heart rates and blood pressures were less intense after the patients consumed ESW.

### Example 6

### Apparatus for Preparation of ESW

Machine Specifications Include:
Stainless steel frame and cabinet
Machine (Reaction Box) size: Height 92″, Length 144″, Width 90″
Machine inlet let 6″ PVC flange
Machine outlet line 6″ PVC flange
Machine closed flow rate 474 GPM (1794 LPM)
Operating pressure 35 psi
Power requirements 600 volt 3 phase 40 amp
Machine operating temperature 33 F. (0.5 C.)
Operating temperature conditions 9 C. to 30 C
Machine in-feed and out-feed isolation valves

### Controls Include:

Stainless steel NEMA™ 4× control panel c/w disconnect
Allen Bradley™ PLC control and rack
Panel view operators color interface
Seametric analog flow meter c/w readout
Temperature thermocouple process line in and out
A/B stack light for status and alarms
AFD 30 hp 600 volt process pump inverter
Tank level controller Mag-Tech c/w 4-20 ma transmitter
Tank upper operating level s/s float switches
Pressure transducer for processor inlet line
DC control panel c/w dead font cell fusing
DC control panel controller and operating boards
WTW MIQ/C184 terminal O2 controller
Line pressure gauges (oil filled)

Tank Specifications Include:
U.S. 3822 gallon vertical stainless steel insulated tank
20″ manway for tank entry
6″ top inlet s/s flange
6″ bottom outlet s/s flange
Tank pressure rating 40 psi
Tank height 188″ F/F
Tank diameter 88″ OD

Pump Specifications Include:
30 horsepower FRISTAM™ model #1151
1750 rpm 4″ triclamp connections suction and discharge
Discharge rated for 600 gpm at 50 psi water

See the detailed description and FIGS for more information. Municipal treated water or spring water can be pre-filtered and placed into a 4,000 US gallon stainless steel conical contact tank. Cell header discharge piping enters the top of the tank through a vertical conduit which can be tank centered and which immerses to a depth of 72 inches.

The water can be re-circulated from the tank through the 40 cells in the reaction chamber and back to the tank by the main system pump which can be controlled by a frequency inverter. A proportional integral derivative closed loop control can be utilized. A second pump then re-circulates water from the bottom of the contact tank to a heat exchanger and then back to the top of the tank. At a predetermined level within the contact tank, a chiller unit refrigerates glycol which passes through the heat exchanger and chills the water to the constant range of 33° F. to 35° F.

As excited water flows from the cell discharge headers to the vertical tank conduit, a mixing chamber can be created in the tank. An amalgamation of semi-excited water and excited water can be mixed.

A pressurized clean air blanket can be induced on the set level of water. A gap of 12 inches can be maintained on the dome. A constant regulated air pressure of 35 psi can be maintained on the vessel.

An output instruction can be used to control pressure, liquid level, and the flow rate of the process loop. The instruction controls a closed loop using inputs from an analog input module and providing an output to an analog output module as a response to effectively hold a process variable at a desired set point. Once the predetermined parameters relating to pressure, temperature and flow can be reached and maintained, the system's PLC initiates power to the cells in the reaction chamber.

The electrical circuitry consists of an isolation transformer (k-8) windings that step down the primary 600 volts 3 ph to a multiple tap secondary of 10-20 volts AC, 3 ph. The 3 ph AC secondary can be fed into a 500 amp Thyristor for conversion. A three phase Thyristor DC converter can be utilized for cell excitement with 6 SCR'S and a 4 quadrant circuit arrangement. The reactor can be gate triggered into conduction via firing boards. The reaction output load can be fed into a divisionary board. A PLC enables a PID ramp sequence that applies direct current to the cells. Cell amps and voltages can be time ramped up and down to excite the cell plates. Alternation of DC power to the cells can be reversed every 30 minutes. Currents can be first applied at 5.0 amp DC per cell and voltages that can be relevant to the conductivity of incoming supply water. Time ramping begins and continues until approximately 10 amps per cell can be maintained.

Cells can be constructed with 3″ rigid PVC tube approximately 47.5″ long with a PVC plate spacer inset and tightly enclosed. A separate end cap holds the cell assembly in place. There can be 2 sections of 4 flat plates approximately 40″ in length and 2″ wide made of Titanium with a plating of 100 microinches of Platinum coating in order to achieve maximum conduction. The plates can be spaced at 0.250 inch between the positive and negative sets. They can be terminated with a stainless steel 316 stud that exits the cell.

The water flow rate per cell can be laminar and calibrated with a non-evasive flow meter and logged.

The complete production process runs 3.5 to 4 hours in a closed loop system with the reaction chamber (cells), contact tank and chilling unit. This produces approximately 3280 US gallons of water in the range of 24-30 mg/l of O₂.

The process comprises electromagnetic treatment of excited water under constant mixing, pressure and electrical pulse ramping. This process could be used to create oxygen cavities in virtually any liquid solution.

The entire teachings of the following documents are herein by reference: U.S. Pat. No. 6,217,712 B1, granted Apr. 17, 2001; U.S. application Ser. No. 09/679,371, tiled Oct. 5, 2000; U.S. application Ser. No. 09/412,359, filed Oct. 5, 1999; and U.S. application Ser. No. 08/760,342, filed Dec. 4, 1996.

While this invention has been particularly shown and described with references to preferred embodiments thereof, it will be understood by those skilled in the art that various changes in form and details may be made therein without departing from the scope of the invention encompassed herein.

What is claimed is:

1. A method of increasing the solubility of oxygen in water, comprising the step of treating the water by applying an electromagnetic pulse in an amount sufficient to cause the water to dissolve the oxygen beyond the saturation point of untreated water.

2. The method of claim 1, further including the step of combining the treated water with oxygen.

3. The method of claim 1, wherein the electromagnetic pulse is applied by contacting the water with electromagnetic plates, whereby a thyristor fires the electrical pulse in a range of between about 5 amps and about 10 amps.

4. The method of claim 3, wherein the amps are ramped up to a maximum of about 9.5 amps per cell.

5. The method of claim 1, wherein the thyristor and the plates are components of an electrical circuit that includes twelve silicon controlled rectifiers arranged as a four quadrant operation.

6. The method of claim 2, wherein the water is maintained at a temperature in a range of between about 33° F. and about 35° F.

7. The method of claim 2, wherein an isolation transformer step down a primary 600 volts, 3-phase, to a multiple tap secondary in a range between about 10 volts and about 20 volts alternating current, 3-phase, and whereby the 3-phase secondary is fed into the thyristor for conversion.

8. The method of claim 3, wherein the thyristor is a 500 amp thyristor.

9. The method of claim 8, wherein the electromagnetic pulse is applied to the water in a reactor that is gate-triggered into conduction via firing boards.

10. The method of claim 9, wherein the electromagnetic plates are arranged in cells, and wherein the cells are within the reactor.

11. The method of claim 10, further including the step of directing the water through at least one cell in the reactor.

12. The method of claim 2, wherein the water is directed through at least one cell under laminar flow conditions.

13. The method of claim 12, wherein the current applied to each cell is reversed periodically.

14. The method of claim 13, wherein the period is in a range of between about 20 and 40 minutes.

15. The method of claim 14, wherein the period is about 30 minutes.

16. A method of increasing the solubility of oxygen in water, comprising the step of treating the water by actuating an electrical circuit coupled to at least two electrode plates and including a thyristor, wherein actuation of the electrical circuit administers an electrical pulse to water and oxygen conducted through a conduit of at least one cell.

17. The method of claim 16, wherein the water is maintained at a temperature in a range of between about 0.55° C. and about 1.67° C.

18. The method of claim 16, wherein the water is maintained at an elevated pressure.

19. The method of claim 18, wherein the pressure is about 241 kilopascals.
